(19) United States
(12) Patent Application Publication
(10) Pub. No.: US 2017/0019473 A1
(43) Pub. Date: Jan. 19, 2017

(54) MULTI-NETWORK MIRRORING SYSTEMS AND METHODS

(71) Applicant: Promethean Limited, Blackburn (GB)

(72) Inventors: Sriraman Venkataraman, Atlanta, GA (US); Steve Benfield, Atlanta, GA (US); Verlin Henderson, Atlanta, GA (US); Andrew Edwardson, Bradford (GB); Paul Wareing, Blackburn (GB)

(21) Appl. No.: 14/801,579

(22) Filed: Jul. 16, 2015

(51) Int. Cl. H04L 29/08; H04L 12/24

(52) U.S. Cl. CPC H04L 67/1095; H04L 41/22

(57) ABSTRACT

A system and method for displaying information from multiple remote computing devices on an interactive display by receiving a first set of information from a first remote computing device that is connected to a first local area network via a first network communication device such as via Ethernet. A second set of information is received from a second remote computing device that is connected to a second local area network via a second network communication device such as Wi-Fi. The system mirrors a first display for the first remote computing device and mirrors a second display for the second remote computing device on an interactive display. This allows two users to simultaneously mirror content from two remote computing devices onto the same interactive display. In an alternate embodiment, the second network communication device may be configured to operate as a wireless access point.

### BACKGROUND

Establishments typically have multiple networks—a first for allowing employees to access the company local area network and the second for allowing guests to gain access to the internet. This type of setup is similar to local area networks found in schools. For example, in many schools a first teacher local area network is available for teachers and administrators to connect to in order to access school specific applications and the internet, and a second students' local area network is available for the students to connect to student specific applications and the internet.

The use of multiple networks can make collaborating between groups of individuals very difficult. For example, when a group of individuals are engaged in a collaborative presentation, some of the individuals in the group may be connected to the first network while others in the group may be connected to the second network. Current mirroring systems allow a user to connect a mobile device such as a mobile phone or a remote computing device to a remote display when connecting to a network. These systems allow the user to mirror the content from the mobile computing device onto the remote display so that others may also view the content. These systems require the user to connect to a mirroring device such as Apple TV® or Chromecast® that connects to the same network to which the user's device is connected. However, when a second user attempts to connect to the mirroring device, the first user is kicked off and the second user is then able to control the content that is displayed from the second user's mobile device. Accordingly, there is currently a need for improved systems and methods for mirroring content from multiple users over multiple networks to allow various groups of users to share the same remote display.

### SUMMARY OF THE VARIOUS EMBODIMENTS

In general, in various embodiments, a system is adapted for displaying information from multiple remote computing devices on a display. The system comprises: (1) one or more processors; (2) a first network communication device that is configured to connect to a first local area network; (3) a second network communication device that is configured to connect to a second local area network, wherein the first network communication device and the second network communication device are simultaneously active; and (4) a first output is configured to couple to an interactive display. The system is configured for receiving, via the first network communication device, a first set of information from a first remote computing device that is operatively connected to the first local area network. The system is further configured for receiving, via the second network communication device, a second set of information from a second remote computing device that is operatively connected to the second local area network. The system is also configured for mirroring at least a portion of a first display for the first remote computing device based at least partially on the first set of information on the interactive display. The system is further configured for mirroring at least a portion of a second display for the second remote computing device based at least partially on the second set of information on the interactive display.

According to various embodiments, a method is adapted for mirroring information from a plurality of computing devices on a display using a plurality of local area networks. The method comprises operatively connecting, via a first communication device, one or more processors with a first local area network. The method also comprises operatively connecting, via a second communication device, the one or more processors with a second local area network. The method comprises receiving, via the first local area network, a first set of information from a first remote computing device having a first display. The method also comprises receiving, via the second local area network, a second set of information from a second remote computing device having a second display. In various embodiments, the method comprises mirroring, via the one or more processors, at least a portion of the first display for the first remote computing device on the display at least partially based on the first set of information. The method further comprises mirroring, via the one or more processors, at least a portion of the second display for the second remote computing device on the display at least partially based on the second set of information.

In general, according to various embodiments, a system is adapted for displaying information from multiple remote computing devices on a display. The system comprises: (1) one or more processors; (2) a first network communication device that is configured to connect to a first local area network; (3) a second network communication device that is configured to operate as a wireless access point that can wirelessly connect to one or more remote computing devices; and (4) a first output configured to couple to a display. The system is configured for receiving, via the first network communication device, a first set of information from a first remote computing device that is operatively connected to the first local area network. The system is also configured for receiving, via the second network communication device, a second set of information from a second remote computing device. The system is further configured for mirroring on the display at least a portion of a first display for the first remote computing device based at least partially on the first set of information. The system is also configured for mirroring on the display at least a portion of a second display for the second remote computing device based at least partially on the second set of information.

### BRIEF DESCRIPTION OF THE DRAWINGS

Various embodiments of a multi-network mirroring systems and methods are described below. In the course of this description, reference will be made to the accompanying drawings, which are not necessarily drawn to scale and wherein:

FIG. 1A is a block diagram of a multi-network mirroring system in accordance with an embodiment of the present system;

FIG. 1B is a block diagram of a multi-network mirroring system according to an alternate embodiment;

FIG. 2 is a block diagram of a computing device for use in the multi-network communication box of FIG. 1;

FIG. 3 is a block diagram of the multi-network communication box of FIG. 1;

FIG. 4 illustrates a flowchart that generally illustrates various steps executed by a multi-network mirroring module according to a particular embodiment;

FIG. 5 illustrates a flowchart that generally illustrates various steps executed by an access point mirroring module according to a particular embodiment; and

FIG. 6 illustrates an exemplary multi-network mirroring system according to various embodiments.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In general, a system and method, according to various embodiments, is adapted for mirroring information from multiple remote computing devices onto a display using multiple local area networks. The system allows one or more users to display content from one or more remote computing devices simultaneously on a display. In various embodiments, the display is an interactive display that allows the user to annotate and comment through a transparent virtual layer formed over the displayed content. The system may, in various embodiments, receive mirroring content from a first remote computing device that is connected to a first network such as the user's home network. The system may also receive mirroring content from a second remote computing device that is connected to a second network such as the user's guest network. The system may then mirror the content from the first remote computing device and mirror the content from the second remote computing device onto an interactive display such as a touch-enabled whiteboard or display. This allows the users to view at least a portion of the content from both remote computing devices on a potentially larger display and allows multiple users to collaborate while connected to different networks. For example, in a classroom setting, the teacher can be connected to a teachers' local area network while the students are connected to a students' local area network. Through the use of the system, both the teacher and one or more students may mirror the information on a display for their mobile computing device onto a main interactive display that is in the classroom. Mirroring of the information for the teacher and/or one or more students may be displayed simultaneously on the interactive display. In this way, the students and teacher may collaborate while connected to different local area networks.

In various embodiments, the system includes a multi-network communication box that enables multiple users on multiple networks to mirror content onto a single display. The multi-network communication box includes one or more communication devices such as a network card, Wi-Fi device, Ethernet port, etc. The one or more communication devices are enabled to each connect to a different network (e.g., wired or wireless). The multi-network communication box also includes a graphics card for receiving graphic media to display on the interactive display. In various embodiments, the multi-network communication box includes ram memory and storage memory. In particular embodiments, the multi-network communication box also includes one or more output ports and one or more input ports for transmitting and receiving content from and to an interactive display.

Because the multi-network communication box is able to connect to multiple networks, companies are able to provide guests with access to a guest network rather than allowing guests or non-employees to connect to the company's corporate network. The multi-network communication box also allows schools to provide students access to a student network without providing them access to a teacher's network in order to collaborate with a teacher and other students while in the classroom. Thus, the system allows groups of users to connect to different networks while still collaborating on a central interactive display.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of Internet-implemented computer software. Any suitable computer-readable storage medium may be utilized including, for example, hard disks, thumb drives, compact disks, DVDs, optical storage devices, and/or magnetic storage devices.

Various embodiments are described below with reference to block diagram and flowchart illustrations of methods, apparatuses, (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus that can direct a computer or other programmable data processing apparatus to function in a particular manner such that the instructions stored in the computer-readable memory produce an article of manufacture that is configured for implementing the functions specified in the flowchart block or blocks.

The computer instructions may execute entirely on the user's computer, partly on the user's computer, as a stand-alone software package, partly on a user's computer and partly on a remote computer, or entirely on the remote computer or server. In the latter scenario, the remote computer may be connected to the user's computer through any suitable type of network, including but not limited to: (1) a local area network (LAN); (2) a wide area network (WAN); and/or (3) a cellular network. It should be understood that a particular computer's connection to the network may be made via an external computer (for example, by connecting to the Internet via a “hotspot” provided by a portable wireless device).

The computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer-implemented process (e.g., method) such that the instructions that execute on the computer or other programmable apparatus provide steps for implementing the functions specified in the flowchart block or blocks.

### Example System Architecture

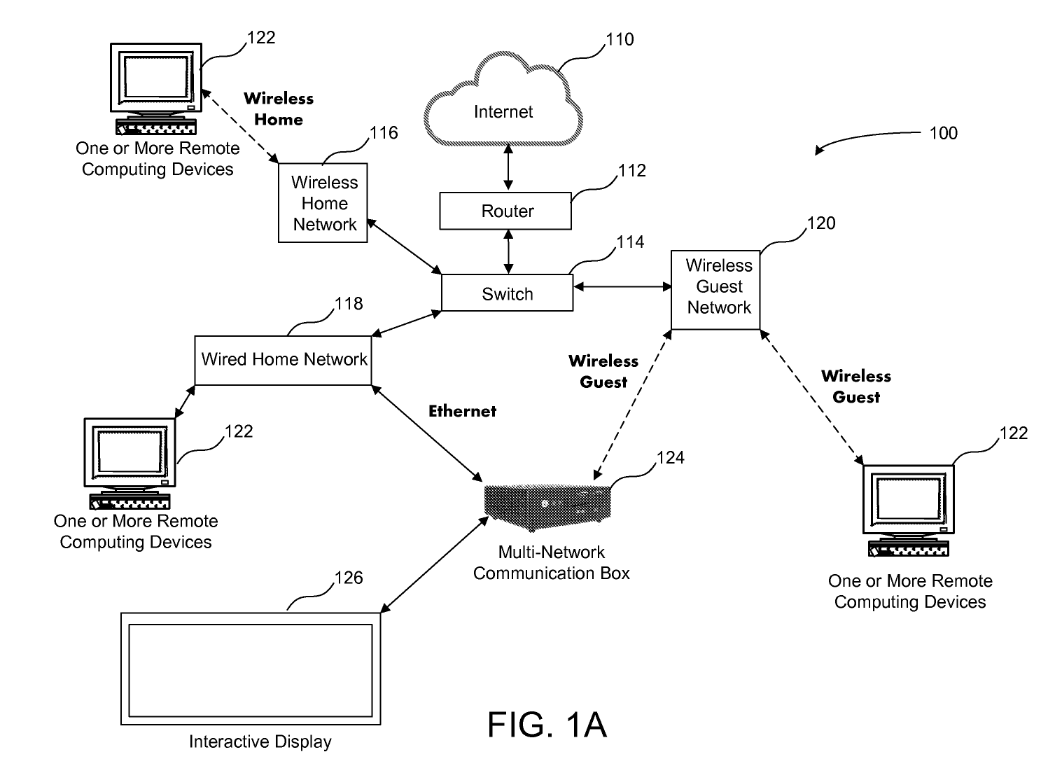

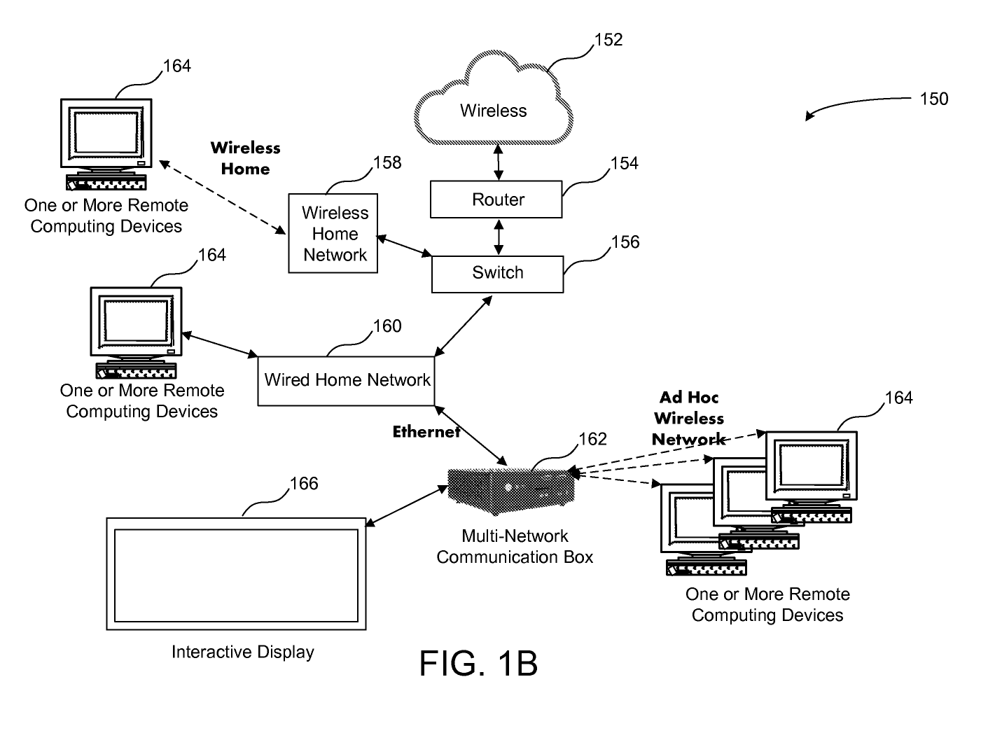

FIG. 1A is a block diagram of a multi-network mirroring system 100 according to particular embodiments. As may be understood from this figure, the multi-network mirroring system 100 includes Internet 110, a router 112, and a switch 114. The switch 114 may be operatively coupled to a wireless home network 116 (e.g., a corporate network, a teachers' network, etc.), a wired home network 118 (e.g., a corporate network, a teachers' network, etc.), and/or a wireless guest network 120 (e.g., a business guest network, a students' network, etc.) such that these networks may access the Internet 110. The networks 116, 118, 120 may include any of a variety of types of wired or wireless computer networks such as the Internet (or other WAN), a private intranet, a mesh network, a public switch telephone network (PSTN), or any other type of network (e.g., a network that uses Bluetooth, beacon communication technologies, and/or near field communications to facilitate communication between computing devices). In various embodiments, one or more remote computing devices 122 may be operatively coupled to any one of the wireless home network 116, the wired home network 118, or the wireless guest network 120. The communication link between the one or more remote computing devices 122 and the wired home network 118 may be, for example, implemented via an Ethernet connection. The communication link between the one or more remote computing devices 122 and the wireless home network 116 or the wireless guest network 120 may be, for example, implemented via a wireless connection (e.g., Wi-Fi, etc.).

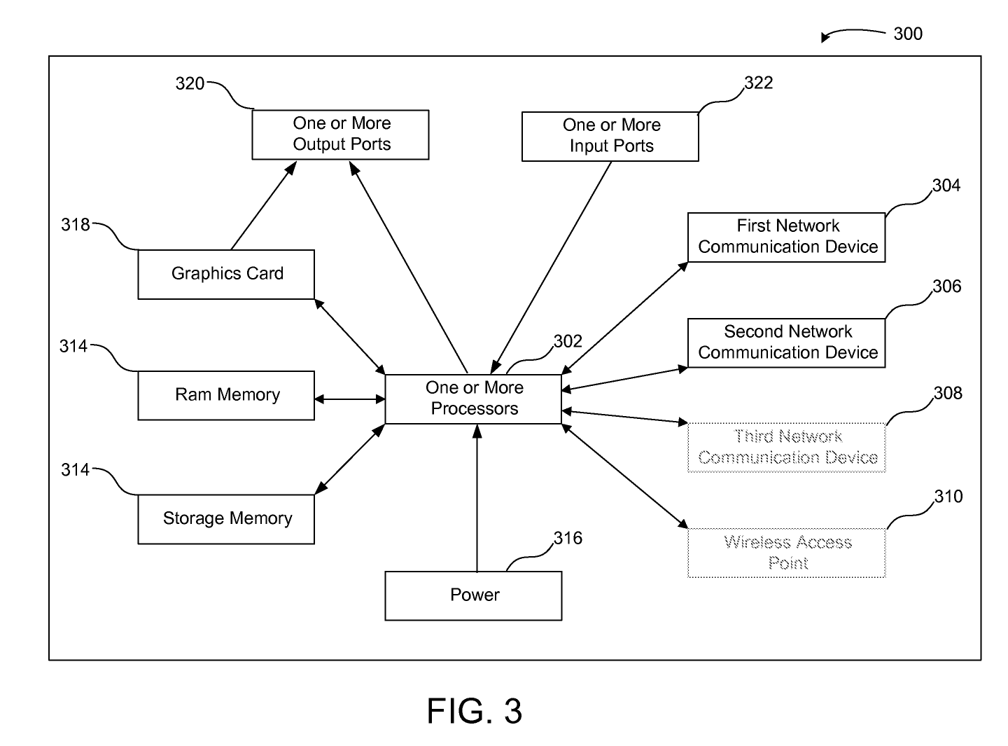

One or more of the networks 116, 118, 120 may be operatively connected to a multi-network communication box 124. The multi-network communication box 124, discussed further in reference to FIG. 3 below, may be operatively coupled to an interactive display 126 and one or more of the wired 118 or wireless networks 116, 120. In particular embodiments, the multi-network connection box 124 may be integrally formed with the interactive display 126. That is, the components and software that resides in the multi-network connection box may be built directly into the interactive display 126. In various embodiments, the interactive display 126 may be an interactive whiteboard, an interactive TV, a multi-sensory input display (received one or more inputs through mouse, keyboard, touch, pointer, sound, gesturing, etc.) or any other suitable interactive display (e.g., a touch enabled whiteboard, a touch enabled display, etc.).

FIG. 1B is a block diagram of an alternate embodiment of a multi-network access point mirroring system 150 according to particular embodiments. Similar to the multi-network mirroring system 100 shown in FIG. 1A, the multi-network access point mirroring system 150 of FIG. 1B includes the Internet 152, a router 154, and a switch 156. The switch 156 may be operatively coupled to a wireless home network 158 and a wired home network 160 such that these networks may access the Internet 152. The networks 158, 160 may include any of a variety of types of wired or wireless computer networks such as the Internet (or other WAN), a private intranet, a mesh network, a public switch telephone network (PSTN), or any other type of network (e.g., a network that uses Bluetooth, beacon communication technologies, and/or near field communications to facilitate communication between computing devices).

The multi-network access point mirroring system 150 also includes a multi-network communication box 162 that may function as a wireless access point to one or more remote computing devices 164. The one or more remote computing devices 164 may be operatively coupled to any one of the wireless home network 158, the wired home network 160, or the multi-network communication box 162 via the wireless access point (e.g., a wireless router, a Bluetooth communication device, etc.) built into the multi-network communication box 162, to form an Ad-hoc wireless network. The communication link between the one or more remote computing devices 164 and the wired home network 160 may be, for example, implemented via an Ethernet connection. In various embodiments, the communication link between the one or more remote computing devices 164 and the wireless home network 158 or the multi-network communication box 162 may be, for example, implemented via a wireless connection. The multi-network communication box 162 may also be operatively coupled to an interactive display 166 via a HDMI connection, a DVI connection or any other suitable connection. In various embodiments, the interactive display 166 may be an interactive whiteboard, an interactive TV, or any other suitable touch enabled display device.

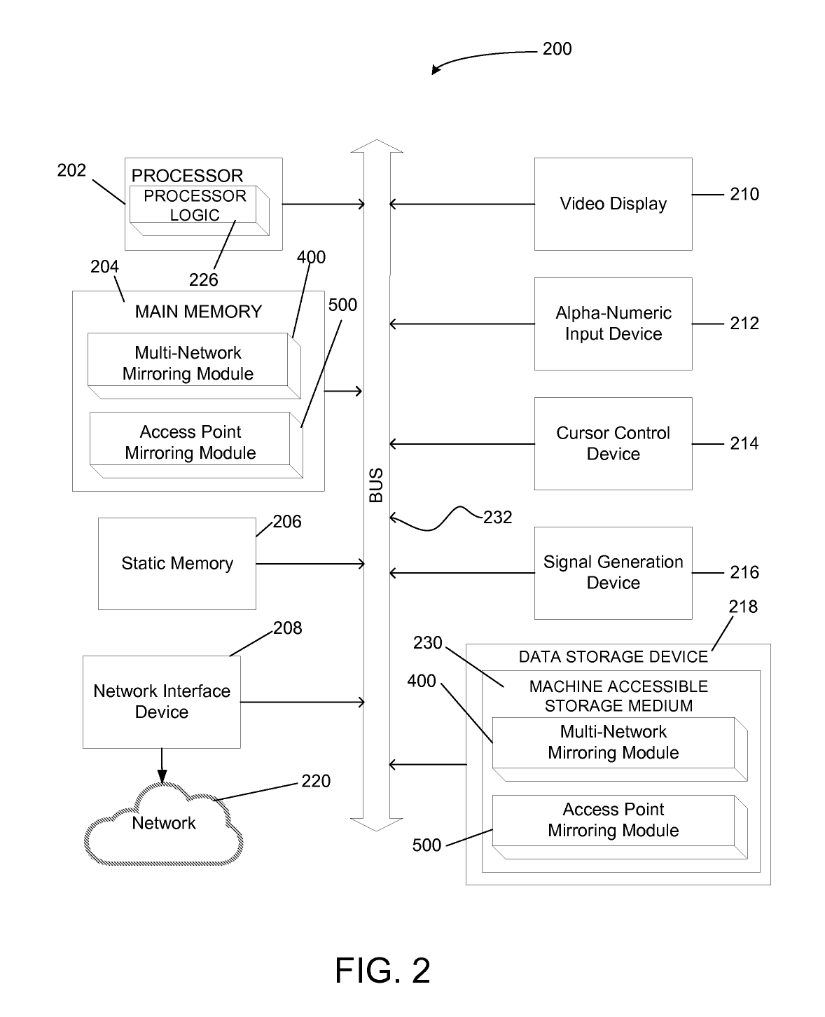

FIG. 2 illustrates a diagrammatic representation of an exemplary architecture of a computer 200 for use in various embodiments of the multi-network mirroring system 100 and/or the multi-network access point mirroring system 150. It should be understood that the computer architecture shown in FIG. 2 may represent the computer architecture for any one of the multi-network communication box 124,162, the one or more remote computing devices 122, 164, and/or the interactive display 126, 166 shown in FIGS. 1 and 2. In particular embodiments, the multi-network communication box 124, 162 may be suitable for use as a computer within the context of the multi-network mirroring system 100 and/or the multi-network access point mirroring system 150, which are configured for displaying, on a display simultaneously, information received from multiple remote computing devices connected to the multi-network communication box 124, 162 over different local area networks.

In particular embodiments, the computer 200 may be connected (e.g., networked) to other computing devices in a LAN, an intranet, an extranet, and/or the Internet as shown in FIGS. 1 and 2. As noted above, the computer 200 may operate in the capacity of a server or a client computing device in a client-server network environment, or as a peer computing device in a peer-to-peer (or distributed) network environment. The computer 200 may be a desktop personal computing device (PC), a tablet PC, a set-top box (STB), a Personal Digital Assistant (PDA), a smartphone, a web appliance, a network router, a switch or bridge, or any other computing device capable of executing a set of instructions (sequential or otherwise) that specify actions to be taken by that computing device. Further, while only a single computing device is illustrated, the term “computing device” shall also be interpreted to include any collection of computing devices that individually or jointly execute a set (or multiple sets) of instructions to perform any one or more of the methodologies discussed herein, or other suitable methodologies.

As shown in FIG. 2, an exemplary computer 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit (CPU), or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 200 may further include a network interface device 208. The computer 200 may also include a video display unit 210 (e.g., a liquid crystal display (LCD) or a cathode ray tube (CRT)), an alpha-numeric input device 212 (e.g., a keyboard), a cursor control device 214 (e.g., a mouse), a signal generation device 216 (e.g., a speaker), and a data storage device 218.

The data storage device 218 may include a non-transitory computing device-accessible storage medium 230 (also known as a non-transitory computing device-readable storage medium, a non-transitory computing device-readable medium, or a non-transitory computer-readable medium) on which is stored one or more sets of instructions (e.g., the multi-network mirroring module 400 and the access point mirroring module 500) embodying any one or more of the methodologies or functions described herein. The one or more sets of instructions may also reside, completely or at least partially, within the main memory 204 and/or within the processing device 202 during execution thereof by the computer 200—the main memory 204 and the processing device 202 also constituting computing device-accessible storage media. The one or more sets of instructions may further be transmitted or received over a network 220 via a network interface device 208.

While the computing device-accessible storage medium 230 is shown in an exemplary embodiment to be a single medium, the term “computing device-accessible storage medium” should be understood to include a single medium or multiple media (e.g., a centralized or distributed database, and/or associated caches and servers) that store the one or more sets of instructions. The term “computing device-accessible storage medium” should also be understood to include any medium that is capable of storing, encoding, or carrying a set of instructions for execution by the computing device and that causes the computing device to include any one or more of the methodologies of the present invention. The terms “computing device-accessible storage medium” and like terms should accordingly be understood to include, but not be limited to, solid-state memories, optical and magnetic media, etc.

FIG. 3 illustrates a diagrammatic representation of exemplary internal components for a multi-network communication box 300. As shown in FIG. 3, the multi-network communication box 300 includes one or more processors 302. The one or more processors 302 may represent one or more general-purpose or specific processing devices such as a microprocessor, a central processing unit (CPU), or the like. More particularly, the one or more processors 302 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The one or more processors 302 may also be one or more special-purpose processing devices such as an application specific integrated circuit (ASIC), a field programmable gate array (FPGA), a digital signal processor (DSP), network processor, or the like. The one or more processors 302 may be configured to execute processing logic for performing various operations and steps discussed herein such as running an operating system (e.g., Windows, iOS, Linux, etc.) as well as other software applications and drivers (e.g., input drivers, interactive display drivers, etc.).

The one or more processors 302 may be operatively coupled to a first network communication device 304 and a second network communication device 306. In various embodiments, the one or more processors 302 may also be operatively coupled to a third network communication device 308. For example, the multi-network communication box 300 may include any suitable number of network communication devices. In particular embodiments, the network communication devices 304, 306 include any one of an Ethernet card, a wireless card, a wireless access card, etc. In various embodiments, the network communication devices 304, 306 may be any suitable communication device. In alternate embodiments, the multi-network communication box 300 may also include a wireless access point 310 (e.g., a wireless router, etc.).

The multi-network communication box 300 also includes ram memory 312, storage memory 314, and a power source 316, which all may be directly or indirectly coupled to the one or more processors 302. In various embodiments, the one or more processors 302 may be operatively connected to a graphics card 318, which is in turn operatively connected to one or more output ports 320 (e.g., an HDMI port, a USB port, a DVI port, a VGA port, a composite video port, etc.) configured for coupling to a display such as a touch enabled display, an interactive white board or any other suitable interactive display. The multi-network communication box 300 also includes one or more input ports 322 for receiving an input device (e.g., a mouse, a keyboard, etc.). The one or more input ports 322 may include a USB port, a Bluetooth connection, etc. In various embodiments, the multi-network communication box 300 may be configured to include drivers that allow the multi-network communication box 300 to receive and respond to touch inputs acquired by the interactive display. Thus, in various embodiments, the multi-network communication box 300 functions as a computing device that is operatively coupled to the interactive display.

### Operation of Exemplary System

As noted above, the multi-network mirroring system 100, according to various embodiments, is adapted to display information from multiple remote computing devices on a display (e.g., a touch enabled display). Various aspects of the system's functionality may be executed by certain system modules, including the multi-network mirroring module 400, which is discussed in more detail below.

Multi-Network Mirroring Module

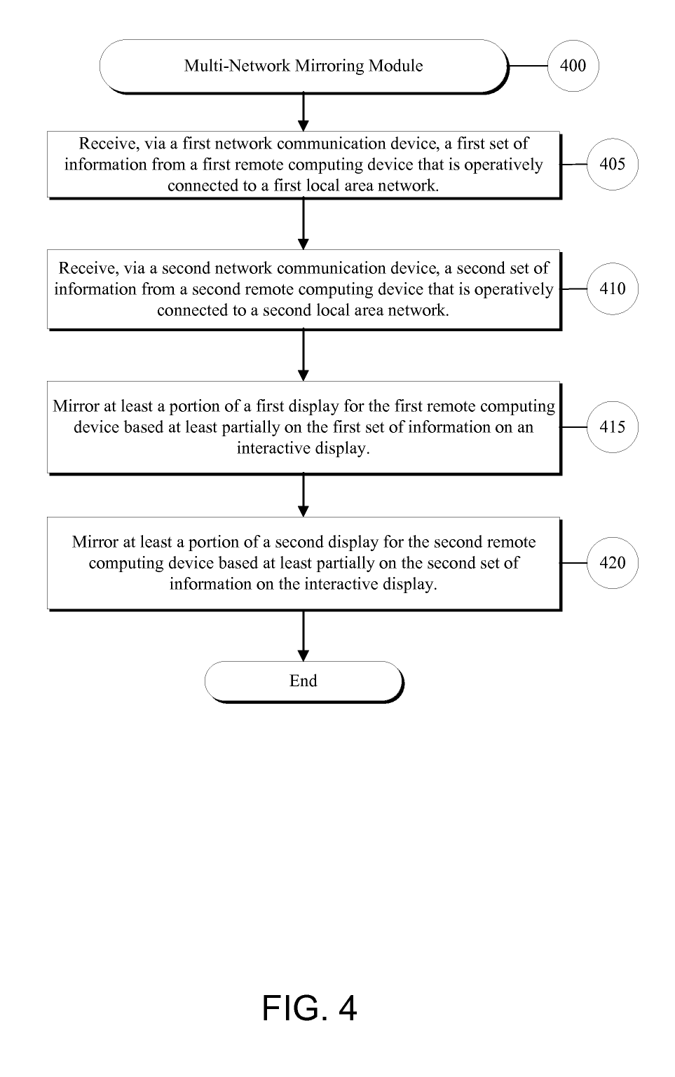

FIG. 4 illustrates a flow chart of operations performed by an exemplary multi-network mirroring module 400, which may, for example, run on the multi-network communication box 124 or any suitable computing device. In particular embodiments, the multi-network mirroring module 400 mirrors information from one or more remote computing devices onto an interactive display.

The system begins, in various embodiments, at Step 405 by receiving, via a first network communication device, a first set of information from a first remote computing device that is operatively connected to a first local area network. In various embodiments, the first network communication device may be any suitable communication device (e.g., Bluetooth device, infrared device, modem, network card using Ethernet, smartphone, Wi-Fi device, etc.). In particular embodiments, the first network communication device is a network card using Ethernet. In various embodiments, the first set of information from the first computing device includes audio and video information, and/or device information for the first computing device. In particular embodiments, the first set of information may include digital media. In various embodiments, the first computing device may be a mobile computing device.

In particular embodiments, the first local area network may be any suitable local area network. In some embodiments, the first local area network may be a home network. In various embodiments, the first local area network may be a corporate network requiring a corporate login and password to access the corporate network. In some embodiments, the first local area network may be a teacher network for teachers and faculty at a school requiring a teacher login and password to access the teacher network. In various embodiments, the first local area network is a wired network. In particular embodiments, the first local area network is a wireless network. In still other embodiments, the first local area network may be both wired and wireless.

At Step 410, the system receives, via a second network communication device, a second set of information from a second remote computing device that is operatively connected to a second local area network. In various embodiments, the second network communication device may be any suitable communication device (e.g., Bluetooth device, infrared device, modem, network card using Ethernet, smartphone, Wi-Fi device, etc.). In particular embodiments, the second network communication device is a Wi-Fi device.

In various embodiments, the second set of information from the second computing device includes audio and video information and/or device information for the second computing device. In particular embodiments, the second set of information may include digital media. In some embodiments, the second computing device may be any suitable computing device (e.g., a desktop personal computing device (PC), a tablet PC, a smartphone, etc. In various embodiments, the second computing device may be a mobile computing device.

In particular embodiments, the second local area network may be any suitable local area network. In some embodiments, the second local area network may be a guest network. In various embodiments, the second local area network may be a corporate guest network requiring a corporate guest login and password to access the corporate guest network. In some embodiments, the second local area network may be a student network for students at a school requiring a student login and password to access the student network. In various embodiments, the second local area network is a wired network. In particular embodiments, the second local area network is a wireless network.

In various embodiments, the first and second set of information may be received substantially simultaneously (e.g., simultaneously). In other embodiments, the first set of information may be received between a time T₀ and T₁₀ while the second set of information may be received between a time T₅ and T₁₈. In other embodiments, the first set of information may be received between a time T₀ and T₁₀ and the second set of information may be received between a time T₁₂ and T₂₃. In any case, all of the above situations constitute receiving the first set of information and the second set of information substantially simultaneously.

The system, at Step 415, mirrors at least a portion of a first display for the first remote computing device based at least partially on the first set of information on an interactive display. In various embodiments, mirroring software can run on the multi-network communication box 124, 162 to allow for the mirroring of information from the first remote computing device onto the interactive display. Thus, any remote computing device running any particular operating system such as ANDROID®, iOS®, LINUX® or WINDOWS® may mirror information onto the interactive display. In various embodiments, information from the first remote computing device can be streamed to the multi-network communication box 124, 162, which is then mirrored on the interactive display 126.

In various embodiments, the system mirrors at least a portion of a first display for the first remote computing device on a first portion of the interactive display 126. In particular embodiments, the system substantially mirrors the entire first display on the first portion of the interactive display 126. In some embodiments, the system mirrors at least a portion of the first display on the entire interactive display 126. In particular embodiments, the system mirrors the entire first display on the entire interactive display. In various embodiments, the mirrored at least a portion of the first display changes substantially simultaneously on the interactive display as the at least a portion of the first display changes on the first remote computing device. For example, when a user opens an application on the user's remote computing device, the interactive display simultaneously shows the application being opened. In particular embodiments, the system is configured to capture an image of the mirrored at least a portion of the first display. In some embodiments, the image is stored in memory for later use.

In various embodiments, the interactive display is a touch enabled display. In particular embodiments, the touch enabled display is an interactive whiteboard that is operatively coupled to one or more processors. In some embodiments, the interactive display may be used to change the display on the first remote computing device. For example, a user may move the image on the interactive display by sliding a pen along the touch enabled interactive display and, in response, the display of the user's mobile device will also move in unison with the interactive display. This allows the user to control the interactive display from either the interactive display or from the user's remote computing device.

Continuing to Step 420, the system mirrors at least a portion of a second display for the second remote computing device based at least partially on the second set of information on the interactive display. In various embodiments, the step of mirroring at least a portion of a second display for the second remote computing device occurs substantially simultaneously (e.g., simultaneously) with the step of mirroring at least a portion of the first display for the first remote computing device.

In particular embodiments, the system mirrors at least a portion of the second display for the second remote computing device on a second portion of the interactive display. In various embodiments, the system substantially mirrors the entire second display on the second portion of the interactive display. In some embodiments, the system mirrors at least a portion of the second display on the entire interactive display. In particular embodiments, the system mirrors the entire second display on the entire interactive display. In various embodiments, the mirrored at least a portion of the second display changes substantially simultaneously on the interactive display as the at least a portion of the second display changes on the second remote computing device. For example, when a user opens an application on the user's mobile device, the interactive display simultaneously shows the application being opened. In particular embodiments, the system is configured to capture an image of the mirrored at least a portion of the second display. In some embodiments, the image is stored in memory for later use.

In various embodiments, the system is further configured for forming a transparent virtual annotation layer that is positioned over at least one of the mirrored at a least a portion of the first display and the mirrored at least a portion of the second display. In particular embodiments, the system receives one or more signals via the one or more processors from the interactive display that are generated when a user touches the interactive display. In some embodiments, the system generates annotations on the transparent virtual annotation layer at least partially in response to receiving the signals. In various embodiments, the system displays the annotations as an overlay on the transparent virtual annotation layer.

In particular embodiments, a third local area network may be operatively connected to the one or more processors via a third communication device. In various embodiments, similar to the first local area network and the second local area network, the system receives via the third local area network a third set of information from a third remote computing device having a third display. In some embodiments, the system may mirror, via the one or more processors, at least a portion of the third display for the third remote computing device on the interactive display at least partially based on the third set of information. It should be understood that the at least a portion of the first display for the first remote computing device, the at least a portion of the second display for the second remote computing device and the at least a portion of the third display for the third remote computing device may all be substantially simultaneously displayed on the interactive display.

### Alternate Embodiment

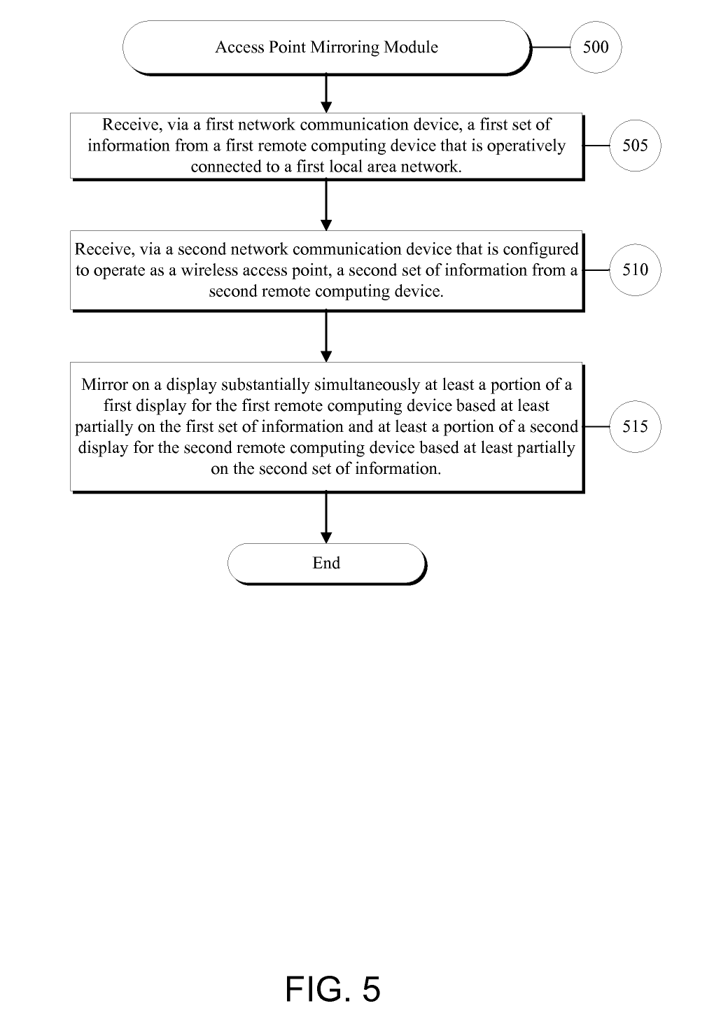

FIG. 5 depicts an alternative embodiment of the multi-network mirroring module 400 of FIG. 4. Thus, for purposes of ease of understanding and clarity, only certain parts will be discussed to highlight the differences between the access point mirroring module 500 and the multi-network mirroring module 400 shown in FIG. 4.

As noted above, in an alternate embodiment, the multi-network access point mirroring system 150, according to various embodiments, is adapted to display information from multiple remote computing devices on a display using the multi-network communication box as an access point. Various aspects of the system's functionality may be executed by certain system modules, including the access point mirroring module 500. The access point mirroring module 500 is discussed in greater detail below.

Similar to Step 405 discussed above in reference to FIG. 4, the access point mirroring module 500 of FIG. 5 begins at Step 505 by receiving, via a first network communication device, a first set of information from a first remote computing device that is operatively connected to a first local area network. In various embodiments, the first local area network may be a wireless local area network or a wired local area network. In particular embodiments, the first network communication device may include any suitable communication device (e.g., Bluetooth device, infrared device, modem, network card using Ethernet, smartphone, Wi-Fi device, etc.).

At Step 510, the system receives, via a second network communication device, a second set of information from a second remote computing device. In various embodiments, the second network communication device is configured to operate as a wireless access point (e.g., a router that sets up an Ad-hoc local area network). In particular embodiments, in operating as a wireless access point, the second network communication device may allow the second remote computing device to connect to a different network than the first local area network to which the first remote computing device is connected. For example, the first local area network and the wireless access point may be different local area networks. In various embodiments, the wireless access point and the first local area network may be the same network allowing different login credentials from different users. For example, the first local area network and the wireless access point may be both part of a corporate network where the first local area network allows users with corporate account information to log in and the wireless access point allows users with guest account information to log in. In particular embodiments, the system may include a third network communication device that is configured to connect to a second local area network. In various embodiments, the system may receive, via the third network communication device, a third set of information from a third remote computing device that is operatively connected to the second local area network. In some embodiments, the first local area network is a home network and the third local area network is a guest network.

Continuing to Step 515, the system mirrors on an interactive display substantially simultaneously at least a portion of a first display for the first remote computing device based at least partially on the first set of information and at least a portion of a second display for the second remote computing device based at least partially on the second set of information. In various embodiments, the system may mirror on the display at least a portion of a third display for the third remote computing device based at least partially on the third set of information substantially simultaneously with the at least a portion of the first and second displays.

### Exemplary User Experience

Corporate Application of the Multi-Network Mirroring System

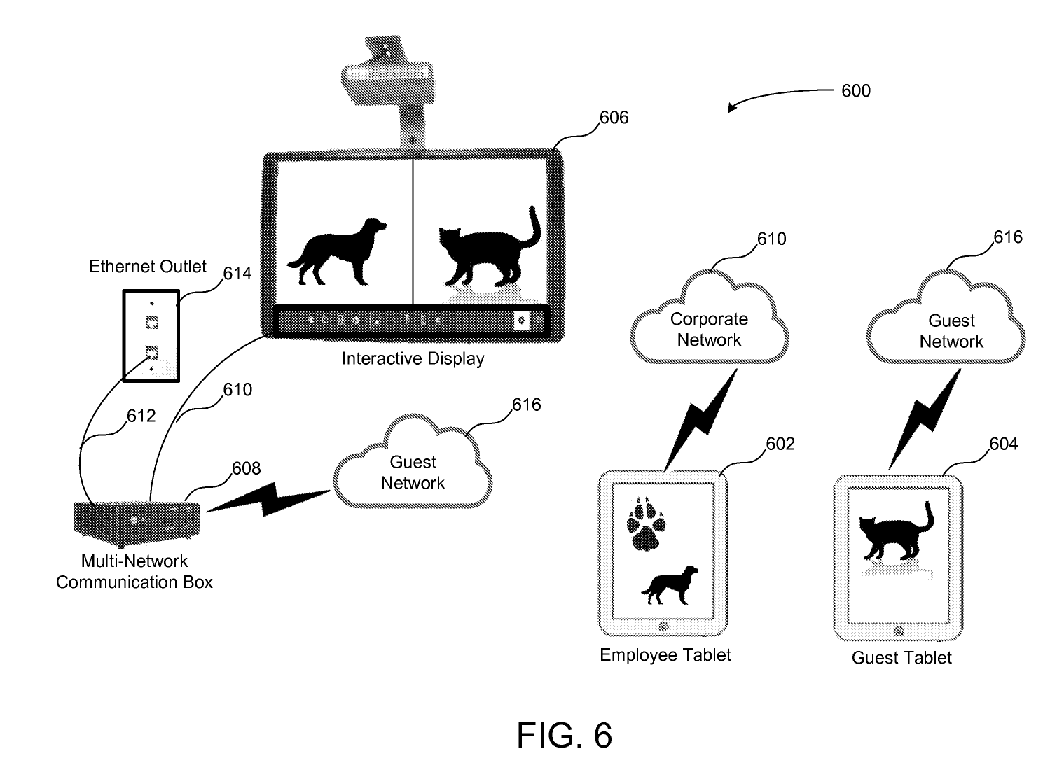

FIG. 6 depicts an exemplary multi-network mirroring system 600 according to various embodiments. The multi-network mirroring system 600 allows two users to display content from the users' remote computing devices 602, 604 onto an interactive display 606. In a particular example of a user using the multi-network mirroring system 600, a user may connect the multi-network communication box 608 to the interactive display 606 using an HDMI cable 610, for example, or any other suitable connection. The user may plug in the AC adapter (not shown) of the multi-network communication box 608 into a plug. The user may also connect the multi-network communication box 608 to a wired corporate network 610 by plugging an Ethernet cable 612 into the multi-network communication box 608 and connecting the other end of the Ethernet cable 612 to an Ethernet outlet 614. The user may further connect the multi-network communication box 602 to a wireless guest network 616 by using the interactive display 606 to enter credentialing information for the wireless guest network 616.

After all peripherals have been connected, the user may turn on the multi-network communication box 608 and use the interactive display 606 to set up the multi-network communication box 608. The multi-network communication box 608 may provide instructions on the interactive display 606 such as providing a link a user may enter on a remote computing device 602, 604 for mirroring to the interactive display 606. The instructions may also indicate that the user can connect to the interactive display 606 from a device by selecting a mirroring icon on the remote computing device 602, 604. The instructions may also include that the multi-network communication box 608 and the remote computing device 602, 604 should be connected to either the corporate network 610 or the guest network 616.

After the multi-network communication box 608 has been set up to one or more networks such as the wired corporate network 610 and the wireless guest network 616, one or more users connected to either of these networks 610, 616 may mirror content onto the interactive display 606 through the multi-network communication box 608. This may be beneficial for companies that do not want to provide guests with access to the company's home network but still need for the guest to be able to access a network to connect to the interactive display.

For example, a company may invite guest to interact with each other using the interactive display 606. Because the company does not want to give full access to the company's corporate network, the company may provide their guests with access to the wireless guest network 616. After a particular guest has logged into the wireless guest network 616 and the multi-network communication box 608 has been connected to the wireless guest network 616, the guest may begin mirroring content from their respective mobile devices 604 onto the interactive display 606 using the multi-network communication box 608. In addition, because the interactive display 606 is touch enabled, the guest and other users may now control the display 606 from their remote computing devices 602, 604 or from the display 606 itself. This permits seamless mirroring and easier presentation of digital content for a larger audience. In addition, an employee using the employee tablet 602 may wish to only mirror a portion of the content on the employee tablet 602. In this case, the employee may select to mirror the bottom portion of the employee tablet 602 such that only a portion of the employee tablet screen is shown on the interactive display 606. In contrast, the guest may set up the guest tablet 604 to mirror the full screen of the guest tablet 604 onto the interactive display 606.

School Setting for Application of the Multi-Network Mirroring System

Similar to the corporate setting, the multi-network mirroring system 100 may be used in a school setting such as in a classroom. For example, where the school has set up a wired teacher network for teachers and a wireless student network for students, the school may desire to keep teachers on the teacher network and students on the student network. Because the students and teachers are on different networks, ordinarily they would be unable to connect to a mirroring device that may only be connected to a single network. However, because the multi-network communication box includes a first network communication device such as Ethernet and a second network communication device such as Wi-Fi, both the students and the teachers may mirror content onto an interactive display through the multi-network communication box.

In other embodiments where the multi-network mirroring system 100 comprises a multi-network communication box 608 that contains a wireless access point, the teacher may connect to the device using the teacher's network while the students connect directly to the multi-network communication box 608 through an Ad-hoc network created by the wireless access point. In this way, while the students are connected to the device to interact with the teacher in a collaborative environment, access to the internet would not be provided thus eliminating distractions during the class.

### CONCLUSION

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A system for displaying information from multiple remote computing devices on a display, wherein the system comprises:
a. one or more processors;
b. a first network communication device that is configured to connect to a first local area network;
c. a second network communication device that is configured to connect to a second local area network, wherein the first network communication device and the second network communication device are simultaneously active; and
d. a first output configured to couple to an interactive display,
wherein the system is configured for:
i. receiving, via the first network communication device, a first set of information from a first remote computing device that is operatively connected to the first local area network;
ii. receiving, via the second network communication device, a second set of information from a second remote computing device that is operatively connected to the second local area network;
iii. mirroring at least a portion of a first display for the first remote computing device based at least partially on the first set of information on the interactive display; and
iv. mirroring at least a portion of a second display for the second remote computing device based at least partially on the second set of information on the interactive display.

2. The system of claim 1, wherein mirroring at least a portion of the first display and the second display occurs substantially simultaneously.

3. The system of claim 2, wherein mirroring at least a portion of the first display and the second display on the interactive display substantially simultaneously further comprises mirroring the at least a portion of the first display on a first portion of the interactive display and mirroring the at least a portion of the second display on a second portion of the interactive display.

4. The system of claim 1, wherein the system is further configured for:
a. forming a transparent annotation layer that is positioned over at least one of the mirrored at least a portion of the first display and the mirrored at least a portion of the second display;
b. receiving signals via the one or more processors from the interactive display that are generated when a user touches the interactive display;
c. generating annotations on the transparent annotation layer at least partially in response to receiving the signals; and
d. displaying the annotations as an overlay on the transparent annotation layer.

5. The system of claim 1, wherein
a. the first local area network is selected from a group consisting of:
i. a teacher network; and
ii. a corporate network; and
b. the second local area network is selected from a group consisting of:
i. a student network; and
ii. a guest network.

6. The system of claim 1, wherein the system is further configured to capture an image of one of the mirrored at least a portion of the first display or the mirrored at least a portion of the second display.

7. The system of claim 6, wherein the image is stored in memory for later use.

8. A method for mirroring information from a plurality of computing devices on a display using a plurality of local area networks, wherein the method comprises:
a. operatively connecting, via a first communication device, one or more processors with a first local area network;
b. operatively connecting, via a second communication device, the one or more processors with a second local area network;
c. receiving, via the first local area network, a first set of information from a first remote computing device having a first display;
d. receiving, via the second local area network, a second set of information from a second remote computing device having a second display;
e. mirroring, via the one or more processors, at least a portion of the first display for the first remote computing device on the display at least partially based on the first set of information; and
f. mirroring, via the one or more processors, at least a portion of the second display for the second remote computing device on the display at least partially based on the second set of information.

9. The method of claim 8, wherein the step of mirroring at least a portion of the first display and mirroring at least a portion of the second display on the display occurs substantially simultaneously.

10. The method of claim 8, wherein
a. the mirrored at least a portion of the first display changes substantially simultaneously on the display as the at least a portion of the first display changes on the first remote computing device; and
b. the mirrored at least a portion of the second display changes substantially simultaneously on the display as the at least a portion of the second display changes on the second remote computing device.

11. The method of claim 8, wherein the display is a touch enabled display.

12. The method of claim 11, wherein the touch enabled display is an interactive whiteboard that is operatively coupled to the one or more processors.

13. The method of claim 8, wherein the first local area network is a corporate network and the second local area network is a guest network.

14. The method of claim 8, wherein the first local area network and the second local area network are each selected from a group consisting of:
a. a wired network; and
b. a wireless network.

15. The method of claim 8, wherein the method further comprises:
a. operatively connecting, via a third communication device, the one or more processors with a third local area network;
b. receiving, via the third local area network, a third set of information from a third remote computing device having a third display; and
c. mirroring, via the one or more processors, at least a portion of the third display for the third remote computing device on the display at least partially based on the third set of information.

16. A system for displaying information from multiple remote computing devices on a display, wherein the system comprises:
a. one or more processors;
b. a first network communication device that is configured to connect to a first local area network;
c. a second network communication device that is configured to operate as a wireless access point that can wirelessly connect to one or more remote computing devices that are local to the second network communication device; and
d. a first output configured to couple to a display,
wherein the system is configured for:
i. receiving, via the first network communication device, a first set of information from a first remote computing device that is operatively connected to the first local area network;
ii. receiving, via the second network communication device, a second set of information from a second remote computing device;
iii. mirroring on the display at least a portion of a first display for the first remote computing device based at least partially on the first set of information; and
iv. mirroring on the display at least a portion of a second display for the second remote computing device based at least partially on the second set of information.

17. The system of claim 16, wherein mirroring at least a portion of the first display and at least a portion of the second display occurs substantially simultaneously on the display.

18. The system of claim 16, wherein the system further comprises:
a. a third network communication device that is configured to connect to a second local area network;
wherein the system is configured for:
i. receiving, via the third network communication device, a third set of information from a third remote computing device that is operatively connected to the second local area network; and
ii. mirroring on the display at least a portion of a third display for the third remote computing device based at least partially on the third set of information.

19. The system of claim 18, wherein the first local area network is a home network and the third local area network is a guest network.

20. The system of claim 16, wherein the first local area network and the wireless access point comprise different local area networks.
